(19) United States
(12) Patent Application Publication
(10) Pub. No.: US 2014/0057127 A1
(43) Pub. Date: Feb. 27, 2014

(54) METHOD FOR PROCESSING AT LEAST ONE CARBON FIBER, METHOD FOR FABRICATING A CARBON COPPER COMPOSITE, AND CARBON COPPER COMPOSITE

(71) Applicant: Friedrich Kroener, Villach (AT)

(72) Inventor: Friedrich Kroener, Villach (AT)

(73) Assignee: INFINEON TECHNOLOGIES AG, Neubiberg (DE)

(21) Appl. No.: 13/591,265

(22) Filed: Aug. 22, 2012

(51) Int. Cl. C25D 5/54; C25D 5/14; B32B 15/04; C25D 5/50

(52) U.S. Cl. 428/614; 205/159; 205/160

(57) ABSTRACT

A method for processing at least one carbon fiber according to an embodiment may include: electroplating a metal layer over at least one carbon fiber, wherein the metal layer contains a metal, which forms a common phase with carbon and a common phase with copper; and annealing the at least one carbon fiber and the metal layer. A method for processing at least one carbon fiber according to another embodiment may include: electroplating a first metal layer over at least one carbon fiber, wherein the first metal layer contains a metal, which forms a common phase with carbon and a common phase with nickel; electroplating a second metal layer over the first metal layer, wherein the second metal layer contains nickel; and annealing the at least one carbon fiber, the first metal layer and the second metal layer.

### BACKGROUND

Various embodiments relate generally to a method for processing at least one carbon fiber, a method for fabricating a carbon copper composite, and to a carbon copper composite.

Electronic devices, e.g. power electronic devices, generally produce heat during operation. It may be desirable to provide suitable heat sinks to dissipate the heat produced by the electronic devices.

### SUMMARY

A method for processing at least one carbon fiber in accordance with an embodiment may include: electroplating a metal layer over at least one carbon fiber, wherein the metal layer contains or consists of a metal, which forms a common phase with carbon and a common phase with copper; annealing the at least one carbon fiber and the metal layer.

A method for processing at least one carbon fiber in accordance with another embodiment may include: electroplating a first metal layer over at least one carbon fiber, wherein the first metal layer contains or consists of a metal, which forms a common phase with carbon and a common phase with nickel; electroplating a second metal layer over the first metal layer, wherein the second metal layer contains or consists of nickel; annealing the at least one carbon fiber, the first metal layer and the second metal layer.

A method for fabricating a carbon copper composite in accordance with another embodiment may include: providing a plurality of carbon fibers; electroplating a metal layer over the plurality of carbon fibers, wherein the metal layer contains or consists of a metal, which forms a common phase with carbon and a common phase with copper; annealing the plurality of carbon fibers and the metal layer; electroplating a copper layer over the metal layer.

A method for fabricating a carbon copper composite in accordance with another embodiment may include: providing a plurality of carbon fibers; electroplating a first metal layer over the plurality of carbon fibers, wherein the first metal layer contains or consists of a metal, which forms a common phase with carbon and a common phase with nickel; electroplating a second metal layer over the first metal layer, wherein the second metal layer contains or consists of nickel; annealing the plurality of carbon fibers, the first metal layer and the second metal layer; electroplating a copper layer over the second metal layer.

A method for fabricating a carbon copper composite in accordance with another embodiment may include: providing a carbon fiber fabric; electroplating a first metal layer onto the fabric, the first metal layer containing or consisting of chromium or manganese; electroplating a second metal layer onto the first metal layer, the second metal layer containing or consisiting of nickel; annealing the fabric, the first metal layer and the second metal layer; electroplating a copper layer onto the second metal layer.

A carbon copper composite in accordance with another embodiment may include: a plurality of carbon fibers; a metal layer disposed over the carbon fibers, the metal layer containing or consisting of a metal that forms a common phase with carbon and a common phase with copper; a copper layer disposed over the metal layer.

A carbon copper composite in accordance with another embodiment may include: a plurality of carbon fibers; a first metal layer disposed over the carbon fibers, wherein the first metal layer contains or consists of a first metal, which forms a common phase with carbon and a common phase with nickel; a second metal layer disposed over the first metal layer, wherein the second metal layer contains or consists of nickel; a copper layer disposed over the second metal layer.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of various embodiments. In the following description, various embodiments are described with reference to the following drawings, in which:

FIG. 1A shows a method for processing at least one carbon fiber in accordance with an embodiment;

FIG. 1B shows a method for processing at least one carbon fiber in accordance with another embodiment;

FIG. 2A shows a method for fabricating a carbon copper composite in accordance with another embodiment;

FIG. 2B shows a method for fabricating a carbon copper composite in accordance with another embodiment;

FIG. 3 shows a method for fabricating a carbon copper composite in accordance with another embodiment;

FIG. 4 shows a method for fabricating a carbon copper composite in accordance with another embodiment;

FIG. 5 shows a method for fabricating a carbon copper composite in accordance with another embodiment;

FIG. 6 shows a method for fabricating a carbon copper composite in accordance with another embodiment;

FIG. 7A to FIG. 10B illustrate various process stages in a method for fabricating a carbon copper composite in accordance with another embodiment;

FIG. 11 to FIG. 14 show phase diagrams for illustrating aspects of various embodiments;

FIG. 15A and FIG. 15B show electron microcraphs for illustrating aspects of various embodiments.

### DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, logical, and electrical changes may be made without departing from the scope of the invention. The various embodiments are not necessarily mutually exclusive, as some embodiments can be combined with one or more other embodiments to form new embodiments.

Electronic devices, e.g. power electronic devices, generally produce heat during operation. It may be desirable to provide suitable heat sinks to dissipate the heat produced by the electronic devices. A heat sink for a power electronic device or component (e.g. a high power module such as an IGBT (insulated gate bipolar transistor) module) may, for example, mean the intermediate storage of a pulse-like heat loss of a power switch, which may be caused, for example, by a short-circuit-like current upon switch-on of a light bulb during the time the filament of the bulb is cold.

A heat sink may preferably have one or more (e.g. all) of the following properties: an electrical conductivity substantially higher than that of silicon, a thermal conductivity at least equal to that of silicon, a specific heat substantially higher than that of silicon.

Pure copper meets the aforementioned requirements very well. However, the difference between the coefficient of thermal expansion (CTE) of copper (CTE_{Cu}≈16.5*10⁻⁶ K⁻¹) and that of silicon (CTE_{Si}2.6*10⁻⁶ K⁻¹) is rather large so that thermal stress generated in a thin silicon chip and at the silicon-copper interface between the chip and the heat sink due to the CTE difference may be difficult to control.

A composite of carbon fibers and copper (in the following referred to as CCu) has been proposed as alternative heat sink material. Though the thermal conductivity of CCu is not significantly higher than that of silicon, CCu yields a CTE of about 4*10⁻⁶ K⁻¹ to 6*10⁻⁶ K⁻¹, which is much closer to the CTE of silicon (2.6*10⁻⁶ K⁻¹) compared to the CTE of pure copper (16.5*10⁻⁶ K⁻¹). Therefore, the use of CCu as heat sink material may greatly reduce thermal stress and chip bending. Furthermore, the other above-mentioned requirements for a heat sink may be very well fulfilled by CCu.

A conventional method for fabricating CCu is based on electroplating short carbon fibers with copper, and subsequently sintering the fibers in hot presses at temperatures of around 1000° C. and pressures of several dozen bars. It is assumed that sintering is necessary but not yet sufficient for good thermal coupling between the copper and the carbon fibers. Therefore, additives are used in addition to achieve better adhesion of the copper and prevent sliding of the copper on the carbon fibers during thermal cycling stress. A shift of the phase boundary on atomic scale would have a negative effect on both the thermal coupling and the average CTE.

One drawback of the aforementioned conventional method may be seen in that the carbon fiber copper parts may be prefabricated as sintered parts only. Cold fabrication of the composite directly at a wafer may not be possible using this method.

Another drawback of the aforementioned conventional method may be seen in that the additives, which are added to the copper electrolyte during the pre-copper plating of the short carbon fibers to achieve better adhesion of the copper on the fibers, possibly do not wet the surface of the carbon fibers entirely. Furthermore, the additives may have a negative effect on the properties of the copper.

One aspect of various embodiments described herein may be seen in that one or more of the drawbacks of the above-described conventional method may be obviated or substantially reduced.

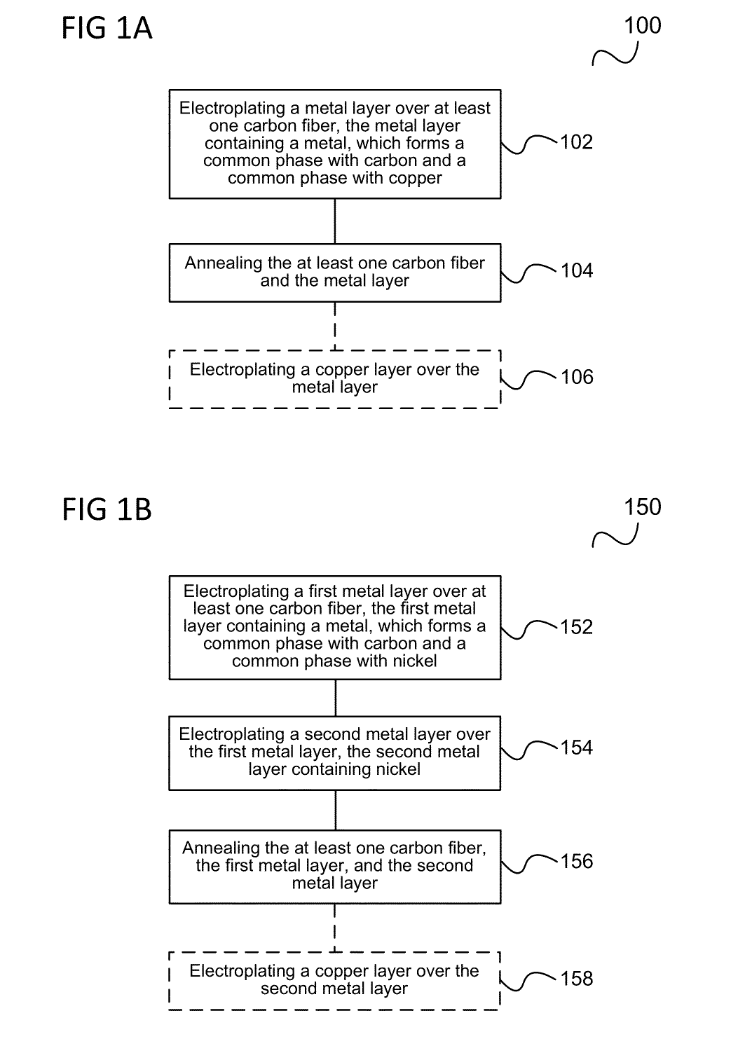

FIG. 1A shows a method 100 for processing at least one carbon fiber in accordance with an embodiment.

In 102, a metal layer may be electroplated (in other words, deposited by means of electroplating or, in still other words, electrolytically deposited, also referred to as galvanic or electrolytic deposition) over at least one carbon fiber (for example a plurality of carbon fibers, e.g. a layer having a plurality of carbon fibers, e.g. a fabric having a plurality of carbon fibers). In other words, the at least one carbon fiber may be coated with a metal.

The term “over” as used herein in expressions such as “electroplated over”, “deposited over”, “disposed over”, “formed over”, “arranged over”, etc., may be understood to include both the case where a first element (structure, layer, etc.) is disposed or formed on a second element (structure, layer, etc.) with direct physical and/or electrical contact, and the case where one or more elements (structures, layers, etc.) may be disposed or formed between the first element (structure, layer, etc.) and the second element (structure, layer, etc.).

In accordance with an embodiment, the at least one carbon fiber may have a length in the millimeter range, for example a few millimeters. Other, e.g. higher, values may be possible as well in accordance with other embodiments. In accordance with one or more embodiments, the at least one carbon fiber may include graphite.

In accordance with another embodiment, the at least one carbon fiber may have a diameter in the range from about 1 μm to about 50 μm. Other values may be possible as well in accordance with other embodiments.

The metal layer may contain or consist of a metal, which forms a common phase with carbon and a common phase with copper.

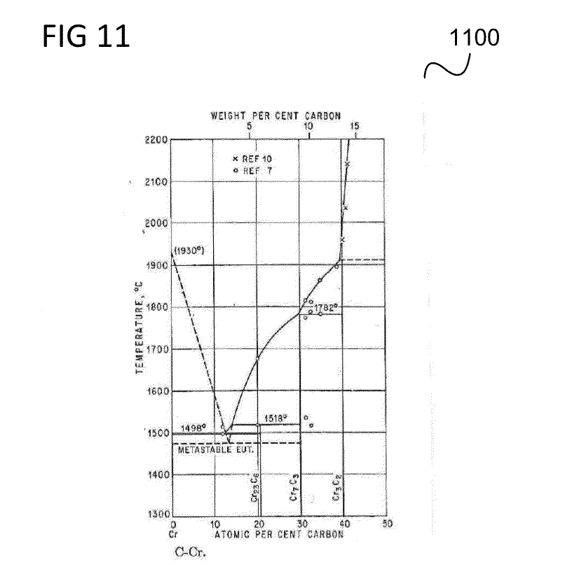

The term “phase” as used herein may be understood to refer to a solid state phase. The term “common phase” as used herein may be understood to refer to a stoichiometrically determined solid state phase of a binary system (in other words, a system of two components), as may be indicated in a corresponding phase diagram of the binary system. For example, the term “common phase of component X and component Y” may be understood to refer to any stoichiometrically determined solid state phase in the phase diagram corresponding to the binary system X-Y. For example, the term “common phase of carbon (C) and chromium (Cr)” may be understood to refer to any stoichiometrically determined solid state phase in the phase diagram corresponding to the binary system C—Cr (see e.g. phase diagram 1100 in FIG. 11).

In accordance with an embodiment, the metal may be chromium (Cr) or manganese (Mn).

In accordance with another embodiment, electroplating the metal layer may include or may be effected by pulsed electroplating (herein also referred to as pulse electroplating, pulse galvanic, or galvanic pulse deposition). The term “pulsed electroplating” as used herein may be understood to refer to an electroplating (electrolytic deposition) technique, in which a plating current may be supplied in one or more pulses of predeterminable duration and/or height.

In accordance with another embodiment, a pulse frequency used in the pulsed electroplating may be in the range from about 10 kHz to about 1 MHz. Other values may be possible as well in accordance with other embodiments.

In accordance with another embodiment, a pulse height of pulses used in the pulsed electroplating may be in the range from about 4 V to about 12 V. Other values may be possible as well in accordance with other embodiments.

In accordance with other embodiments, electroplating the metal layer may be effected by means of other suitable electroplating techniques.

The metal layer may at least partially (e.g. fully) coat the at least one carbon fiber or the plurality of carbon fibers.

In accordance with another embodiment, the metal layer be deposited such that it has a layer thickness that is smaller than the diameter of the at least one carbon fiber, for example substantially smaller than the diameter of the at least one carbon fiber, for example a layer thickness equal to or less than about 25% of the carbon fiber diameter, for example a layer thickness equal to or less than about 15% of the carbon fiber diameter, for example a layer thickness equal to or less than about 10% of the carbon fiber diameter, for example a layer thickness equal to or less than about 5% of the carbon fiber diameter, for example a layer thickness equal to or less than about 1% of the carbon fiber diameter, for example a layer thickness in the range from about 10 nm to about 500 nm. Other values may be possible as well in accordance with other embodiments. The minimal layer thickness may, for example, correspond to the size of crystallization seeds of the metal layer.

In 104, the at least one carbon fiber and the metal layer may be annealed (in other words, heated or tempered). The at least one carbon fiber and the metal layer may be annealed simultaneously, for example in a single processing step.

In accordance with another embodiment, an annealing temperature may be in the range from about 400° C. to about 1000° C. Other values may be possible as well in accordance with other embodiments.

In accordance with another embodiment, an annealing time may be in the range from about 1 h to about 10 h. Other values may be possible as well in accordance with other embodiments.

Annealing the at least one carbon fiber and the metal layer may serve to form a common phase of carbon and the metal of the metal layer, for example at an interface between the at least one carbon fiber and the metal layer.

In accordance with another embodiment, a copper layer may be electroplated over the metal layer, as shown in 106. Electroplating the copper layer may be carried out after annealing the at least one carbon fiber and the metal layer. Electroplating the copper layer may be effected using any suitable electroplating technique, which are known as such in the art.

The metal layer may serve as adhesion layer to enable or improve adhesion of the copper layer, as will be described in more detail further below.

In accordance with another embodiment, the copper layer may be annealed after depositing the copper layer, for example to a temperature in the range from about 110° C. to about 150° C. Annealing may, for example, serve to remove (e.g. vaporize) possible electrolyte residues.

FIG. 1B shows a method 150 for processing at least one carbon fiber in accordance with another embodiment.

In 152, a first metal layer may be electroplated (in other words, deposited by means of electroplating, also referred to as galvanic deposition or electrolytic deposition) over at least one carbon fiber (for example a plurality of carbon fibers, e.g. a layer having a plurality of carbon fibers, e.g. a fabric having a plurality of carbon fibers). In other words, the at least one carbon fiber may be coated with a metal.

In accordance with an embodiment, the at least one carbon fiber may have a length in the millimeter range, for example a few millimeters. Other, e.g. higher, values may be possible as well in accordance with other embodiments.

In accordance with another embodiment, the at least one carbon fiber may have a diameter in the range from about 1 μm to about 50 μm. Other values may be possible as well in accordance with other embodiments.

The first metal layer may contain or consist of a metal, which forms a common phase with carbon and a common phase with nickel. In other words, the metal and carbon may form at least one common phase, and nickel and the metal may form at least one common phase. The metal of the first metal layer may be different from nickel.

The first metal layer may at least partially (e.g. fully) coat the at least one carbon fiber or the plurality of carbon fibers.

In 154, a second metal layer may be electroplated over the first metal layer, wherein the second metal layer may contain or consist of nickel. The second metal layer may, for example, be a nickel layer.

Illustratively, the first metal layer and the second metal layer may be configured such that the metal of the first metal layer and carbon may form a common phase, and the metal of the first metal layer and the metal of the second metal layer may form a common phase.

In accordance with an embodiment, the metal of the first metal layer may be chromium (Cr) or manganese (Mn).

In accordance with another embodiment, electroplating the first metal layer and/or electroplating the second metal layer may include or may be effected by pulsed electroplating (herein also referred to as pulse electroplating or galvanic pulse deposition).

In accordance with another embodiment, a pulse frequency of pulses used in the pulsed electroplating may be in the range from about 10 kHz to about 1 MHz. Other values may be possible as well in accordance with other embodiments.

In accordance with another embodiment, a pulse height of pulses in the pulsed electroplating may be in the range from about 4 V to about 12 V. Other values may be possible as well in accordance with other embodiments.

In accordance with other embodiments, electroplating the first metal layer and/or electroplating the second metal layer may be effected by means of other suitable electroplating techniques.

In accordance with another embodiment, the first metal layer and/or the second metal layer may be deposited such that they have a layer thickness that is smaller than the diameter of the carbon fibers, for example substantially smaller than the diameter of the carbon fibers, for example a layer thickness equal to or less than about 25% of the carbon fiber diameter, for example a layer thickness equal to or less than about 15% of the carbon fiber diameter, for example a layer thickness equal to or less than about 10% of the carbon fiber diameter, for example a layer thickness equal to or less than about 5% of the carbon fiber diameter, for example a layer thickness equal to or less than about 1% of the carbon fiber diameter, for example a layer thickness in the range from about 10 nm to about 500 nm. Other values may be possible as well in accordance with other embodiments. The minimal layer thickness may, for example, correspond to the size of crystallization seeds of the first and/or second metal layer.

In accordance with another embodiment, the first metal layer and the second metal layer may have the same or substantially the same layer thickness.

In 156, the at least one carbon fiber, the first metal layer and the second metal layer may be annealed.

In accordance with an embodiment, the at least one carbon fiber, the first metal layer and the second metal layer may be annealed simultaneously, for example in a single processing step.

In accordance with another embodiment, annealing the at least one carbon fiber and the first metal layer may be carried out before electroplating the second metal layer.

In accordance with another embodiment, an annealing temperature may be in the range from about 400° C. to about 1000° C. Other values may be possible as well in accordance with other embodiments.

In accordance with another embodiment, an annealing time may be in the range from about 1 h to about 10 h. Other values may be possible as well in accordance with other embodiments.

Annealing the at least one carbon fiber, the first metal layer and the second metal layer may serve to form a common phase of carbon and the metal of the first metal layer, for example at an interface between the at least one carbon fiber and the first metal layer, and a common phase of the metal of the first metal layer and the metal of the second metal layer, for example at an interface between the first metal layer and the second metal layer.

In accordance with another embodiment, a copper layer may be electroplated over the second metal layer, as shown in 158. Electroplating the copper layer may be carried out after annealing the at least one carbon fiber, the first metal layer and the second metal layer. Electroplating the copper layer may be effected using any suitable electroplating technique, which are known as such in the art.

The first metal layer and the second metal layer may serve as adhesion layers to enable or improve adhesion of the copper layer, as will be described in more detail further below.

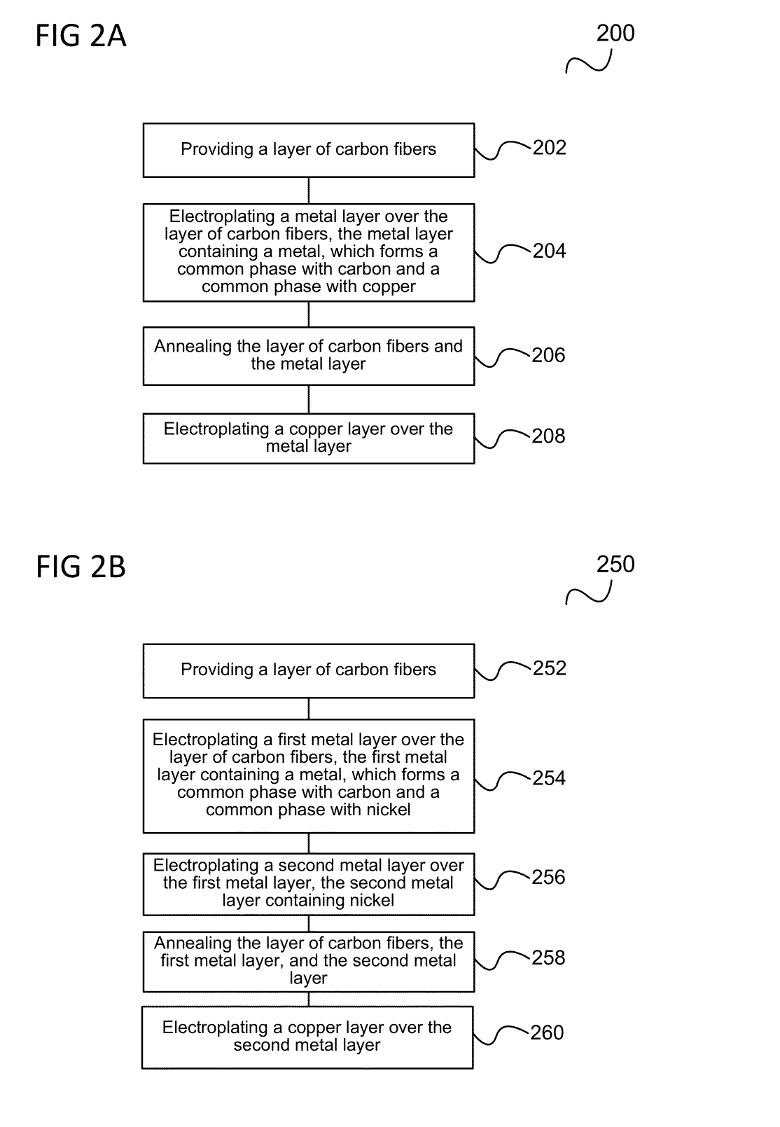

FIG. 2A shows a method 200 for fabricating a carbon copper composite in accordance with another embodiment.

In 202, a plurality of carbon fibers (e.g. a layer having a plurality of carbon fibers) may be provided. The number of carbon fibers may be arbitrary, in general.

In accordance with an embodiment, the plurality of carbon fibers may be configured as a fabric. In other words, the plurality of carbon fibers may be arranged to form a fabric, also referred to as carbon fiber fabric herein. In accordance with one or more embodiments, one or more (e.g. all) of the carbon fibers may include graphite.

In accordance with another embodiment, at least one (for example a plurality, e.g. all) of the carbon fibers may have a length in the millimeter range, for example a few millimeters. Other, e.g. higher, values may be possible as well in accordance with other embodiments.

In accordance with another embodiment, at least one (for example a plurality, e.g. all) of the carbon fibers may have a diameter in the range from about 1 μm to about 50 μm. Other values may be possible as well in accordance with other embodiments.

In 204, a metal layer may be electroplated (in other words, deposited by means of electroplating) over the plurality of carbon fibers.

The metal layer may contain or consist of a metal that forms a common phase with carbon and a common phase with copper.

In accordance with an embodiment, the metal may be chromium (Cr) or manganese (Mn).

In accordance with another embodiment, electroplating the metal layer may include or may be effected by pulsed electroplating (herein also referred to as pulse electroplating or galvanic pulse deposition).

In accordance with another embodiment, a pulse frequency of pulses used in the pulsed electroplating may be in the range from about 10 kHz to about 1 MHz. Other values may be possible as well in accordance with other embodiments.

In accordance with another embodiment, a pulse height of pulses in the pulsed electroplating may be in the range from about 4 V to about 12 V. Other values may be possible as well in accordance with other embodiments.

In accordance with other embodiments, electroplating the metal layer may be effected by means of other suitable electroplating techniques.

The metal layer may at least partially (e.g. fully) coat at least one (for example a plurality, e.g. all) of the carbon fibers.

In accordance with another embodiment, the metal layer may be deposited such that it has a layer thickness that is smaller than the diameter of the carbon fibers, for example substantially smaller than the diameter of the carbon fibers, for example a layer thickness equal to or less than about 25% of the carbon fiber diameter, for example a layer thickness equal to or less than about 15% of the carbon fiber diameter, for example a layer thickness equal to or less than about 10% of the carbon fiber diameter, for example a layer thickness equal to or less than about 5% of the carbon fiber diameter, for example a layer thickness equal to or less than about 1% of the carbon fiber diameter, for example a layer thickness in the range from about 10 nm to about 500 nm. Other values may be possible as well in accordance with other embodiments. The minimal layer thickness may, for example, correspond to the size of crystallization seeds of the metal layer.

In 206, the plurality of carbon fibers and the metal layer may be annealed.

In accordance with an embodiment, an annealing temperature may be in the range from about 400° C. to about 1000° C. Other values may be possible as well in accordance with other embodiments.

In accordance with another embodiment, an annealing time may be in the range from about 1 h to about 10 h. Other values may be possible as well in accordance with other embodiments.

The plurality of carbon fibers and the metal layer may be annealed simultaneously, for example in a single processing step.

Annealing the plurality of carbon fibers and the metal layer may serve to form a common phase of the carbon of the carbon fibers and the metal of the metal layer, for example at interfaces between the carbon fibers and the metal layer.

In 208, a copper layer may be electroplated over the metal layer.

Electroplating the copper layer may be carried out after annealing the plurality of carbon fibers and the metal layer.

Electroplating the copper layer may be effected using any suitable electroplating technique, which are known as such in the art.

The metal layer may serve as adhesion layer to enable or improve adhesion of the copper layer, as will be described in more detail further below.

FIG. 2B shows a method 250 for fabricating a carbon copper composite in accordance with another embodiment.

In 252, a plurality of carbon fibers (e.g. a layer having a plurality of carbon fibers) may be provided. The number of carbon fibers may be arbitrary, in general.

In accordance with an embodiment, the plurality of carbon fibers may be configured as a fabric. In other words, the plurality of carbon fibers may be arranged to form a fabric, also referred to as carbon fiber fabric herein.

In accordance with another embodiment, at least one (for example a plurality, e.g. all) of the carbon fibers may have a length in the millimeter range, for example a few millimeters. Other, e.g. higher, values may be possible as well in accordance with other embodiments.

In accordance with another embodiment, at least one (for example a plurality, e.g. all) of the carbon fibers may have a diameter in the range from 1 μm to about 50 μm. Other values may be possible as well in accordance with other embodiments.

In 254, a first metal layer may be electroplated over the plurality of carbon fibers.

The first metal layer may contain or consist of a metal, which forms a common phase with carbon and a common phase with nickel. In other words, the metal and carbon may form at least one common phase, and nickel and the metal may form at least one common phase. The metal of the first metal layer may be different from nickel.

The first metal layer may at least partially (e.g. fully) coat the at least one carbon fiber or the plurality of carbon fibers.

In 256, a second metal layer may be electroplated over the first metal layer, wherein the second metal layer may contain or consist of nickel.

Illustratively, the first metal layer and the second metal layer may be configured such that the metal of the first metal layer and carbon may form a common phase, and the metal of the first metal layer and nickel may form a common phase, as described above.

In accordance with an embodiment, the metal of the first metal layer may be chromium (Cr) or manganese (Mn).

In accordance with another embodiment, electroplating the first metal layer and/or electroplating the second metal layer may include or may be effected by pulsed electroplating (herein also referred to as pulse electroplating or galvanic pulse deposition).

In accordance with another embodiment, a pulse frequency of pulses used in the pulsed electroplating may be in the range from about 10 kHz to about 1 MHz. Other values may be possible as well in accordance with other embodiments.

In accordance with another embodiment, a pulse height of pulses used in the pulsed electroplating may be in the range from about 4 V to about 12 V. Other values may be possible as well in accordance with other embodiments.

In accordance with other embodiments, electroplating the first metal layer and/or electroplating the second metal layer may be effected by means of other suitable electroplating techniques.

In accordance with another embodiment, the first metal layer and/or the second metal layer may be deposited such that they have a layer thickness that is smaller than the diameter of the carbon fibers, for example substantially smaller than the diameter of the carbon fibers, for example a layer thickness equal to or less than about 25% of the carbon fiber diameter, for example a layer thickness equal to or less than about 15% of the carbon fiber diameter, for example a layer thickness equal to or less than about 10% of the carbon fiber diameter, for example a layer thickness equal to or less than about 5% of the carbon fiber diameter, for example a layer thickness equal to or less than about 1% of the carbon fiber diameter, for example a layer thickness in the range from about 10 nm to about 500 nm. Other values may be possible as well in accordance with other embodiments. The minimal layer thickness may, for example, correspond to the size of crystallization seeds of the first and/or second metal layer.

In accordance with another embodiment, the first metal layer and the second metal layer may have the same or substantially the same layer thickness.

In 258, the plurality of carbon fibers, the first metal layer, and the second metal layer may be annealed.

In accordance with an embodiment, an annealing temperature may be in the range from about 400° C. to about 1000° C. Other values may be possible as well in accordance with other embodiments.

In accordance with another embodiment, an annealing time may be in the range from about 1 h to about 10 h. Other values may be possible as well in accordance with other embodiments.

In accordance with another embodiment, the plurality of carbon fibers, the first metal layer and the second metal layer may be annealed simultaneously, for example in a single processing step.

Annealing the plurality of carbon fibers, the first metal layer and the second metal layer may serve to form a common phase of carbon and the metal of the first metal layer, for example at interfaces between the carbon fibers and the first metal layer, and a common phase of the metal of the first metal layer and the metal of the second metal layer, for example at interfaces between the first metal layer and the second metal layer.

In accordance with another embodiment, annealing the plurality of carbon fibers and the first metal layer may be carried out before electroplating the second metal layer.

In 260, a copper layer may be electroplated over the second metal layer. Electroplating the copper layer may be carried out after annealing the plurality of carbon fibers, the first metal layer and the second metal layer. Electroplating the copper layer may be effected using any suitable electroplating technique, which are known as such in the art.

In accordance with another embodiment, a surface of the second metal layer (e.g. a surface that faces away from the first metal layer) may be activated before electroplating the copper layer over the second metal layer. Activating the surface of the second metal layer may, for example, include or be achieved by bringing the surface into contact with an acid such as hydrochloric acid, e.g. concentrated hydrochloric acid, or other suitable acids, for example for a short time interval (e.g. for about 10 s to about 20 s). In accordance with another embodiment, the surface of the second metal layer may be cleaned after activating the surface. Cleaning the surface may, for example, include or be achieved by purging. By means of activating and/or cleaning, an oxide layer (which may have been formed on the surface of the second metal layer during the annealing) may, for example, be removed.

In accordance with another embodiment, voids possibly remaining between the plurality of carbon fibers after electroplating the copper layer may be filled or joined with copper, for example galvanically or by means of hot pressing.

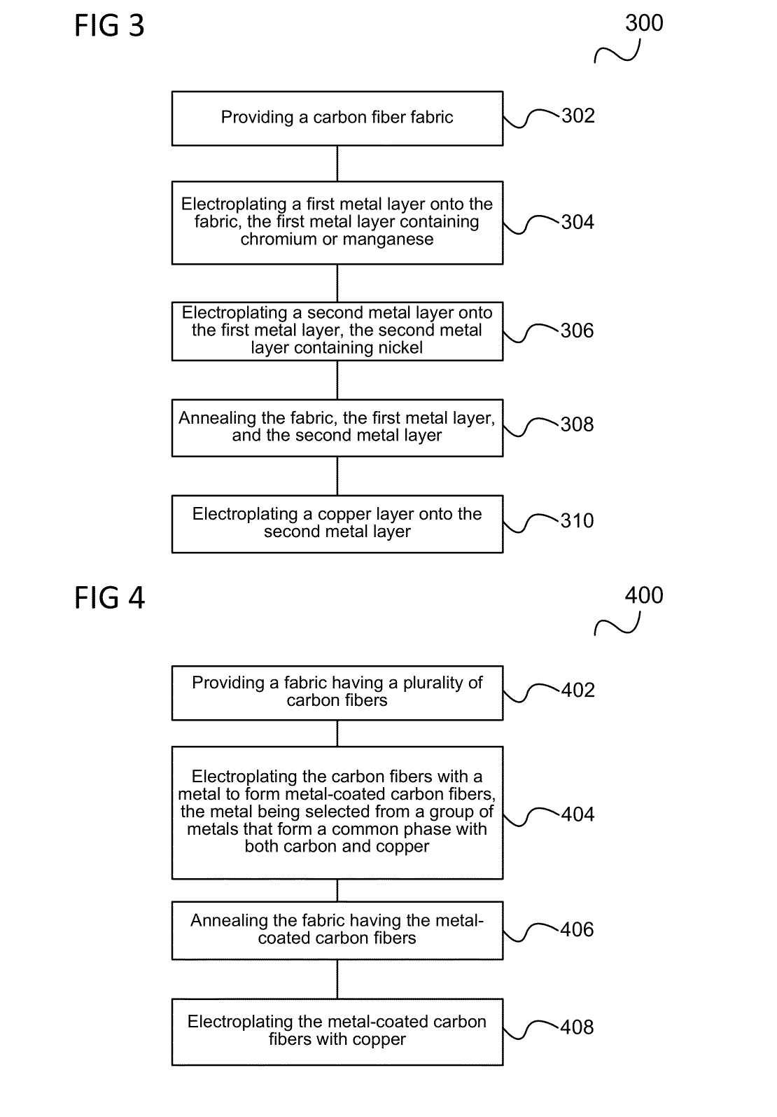

FIG. 3 shows a method 300 for fabricating a carbon copper composite in accordance with another embodiment.

In 302, a carbon fiber fabric may be provided. The fabric may have a plurality of carbon fibers. The carbon fibers may, for example, be configured in accordance with one or more embodiments described herein.

In 304, a first metal layer may be electroplated onto the fabric, for example onto one or more of the plurality of carbon fibers. The first metal layer may contain or consist of chromium or manganese. Electroplating the first metal layer may, for example, be carried out in accordance with one or more embodiments described herein, for example using pulsed electroplating.

In 306, a second metal layer may be electroplated onto the first metal layer, for example onto the carbon fibers coated with the first metal. The second metal layer may contain or consist of nickel. Electroplating the second metal layer may, for example, be carried out in accordance with one or more embodiments described herein, for example using pulsed electroplating.

In 308, the fabric, the first metal layer and the second metal layer may be annealed. Annealing may, for example, be carried out in accordance with one or more embodiments described herein.

In 310, a copper layer may be electroplated onto the second metal layer. Electroplating the copper layer may be carried out after annealing the fabric and the first and second metal layers. Electroplating the copper layer may be effected using any suitable electroplating technique, which are known as such in the art.

In accordance with another embodiment, a surface of the second metal layer (e.g. a surface that faces away from the first metal layer) may be activated and/or cleaned before electroplating the copper layer onto the second metal layer. Activating the surface of the second metal layer may include the removal of an oxide layer (which may have been formed during the annealing) and may, for example, include or be achieved by bringing the surface into contact with an acid such as hydrochloric acid, e.g. concentrated hydrochloric acid, or other suitable acids. Cleaning the surface may be carried out after activating the surface and may, for example, include or be achieved by purging.

In accordance with another embodiment, voids possibly remaining between the plurality of carbon fibers after electroplating the copper layer may be filled or joined with copper, for example galvanically or by means of hot pressing.

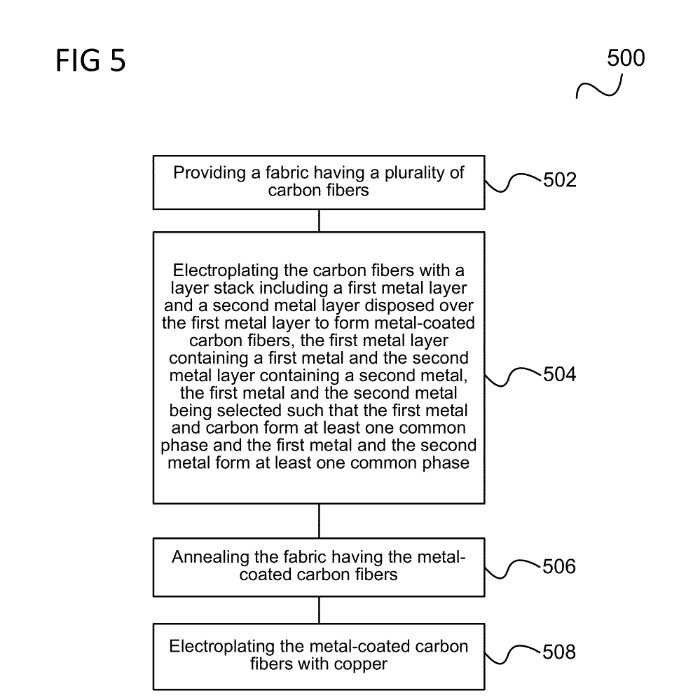

FIG. 4 shows a method 400 for fabricating a carbon copper composite in accordance with another embodiment.

In 402, a fabric having a plurality of carbon fibers may be provided. The fabric and/or carbon fibers may, for example, be configured in accordance with one or more embodiments described herein.

In 404, the carbon fibers may be electroplated with a metal to form metal-coated carbon fibers. Electroplating may, for example, be carried out in accordance with one or more embodiments described herein. The metal may be selected from a group of metals that form a common phase with both carbon and copper. The metal may, for example, be selected in accordance with one or more embodiments described herein.

In 406, the fabric having the metal-coated carbon fibers may be annealed. Annealing may, for example, be carried out in accordance with one or more embodiments described herein.

In 408, the metal-coated carbon fibers may be electroplated with copper. Electroplating the copper may be effected using any suitable electroplating technique, which are known as such in the art. In accordance with some embodiments, the metal-coated carbon fibers may be electroplated with nickel before electroplating copper.

FIG. 5 shows a method 500 for fabricating a carbon copper composite in accordance with another embodiment.

In 502, a fabric having a plurality of carbon fibers may be provided. The fabric and/or carbon fibers may, for example, be configured in accordance with one or more embodiments described herein.

In 504, the carbon fibers may be electroplated with a layer stack including a first metal layer and a second metal layer disposed over the first metal layer to form metal-coated carbon fibers. Electroplating may, for example, be carried out in accordance with one or more embodiments described herein. The first metal layer may contain or may be made of a first metal and the second metal layer may contain or may be made of a second metal. The first metal and the second metal may be selected such that the first metal and carbon form at least one common phase, and the first metal and the second metal form at least one common phase. The first metal and/or second metal may, for example, be selected in accordance with one or more embodiments described herein. For example, in accordance with an embodiment, the first metal may be chromium or manganese. For example, in accordance with another embodiment, the second metal may be nickel.

In 506, the fabric having the metal-coated carbon fibers may be annealed. Annealing may, for example, be carried out in accordance with one or more embodiments described herein.

In 508, the metal-coated carbon fibers may be electroplated with copper. Electroplating the copper layer may be effected using any suitable electroplating technique, which are known as such in the art.

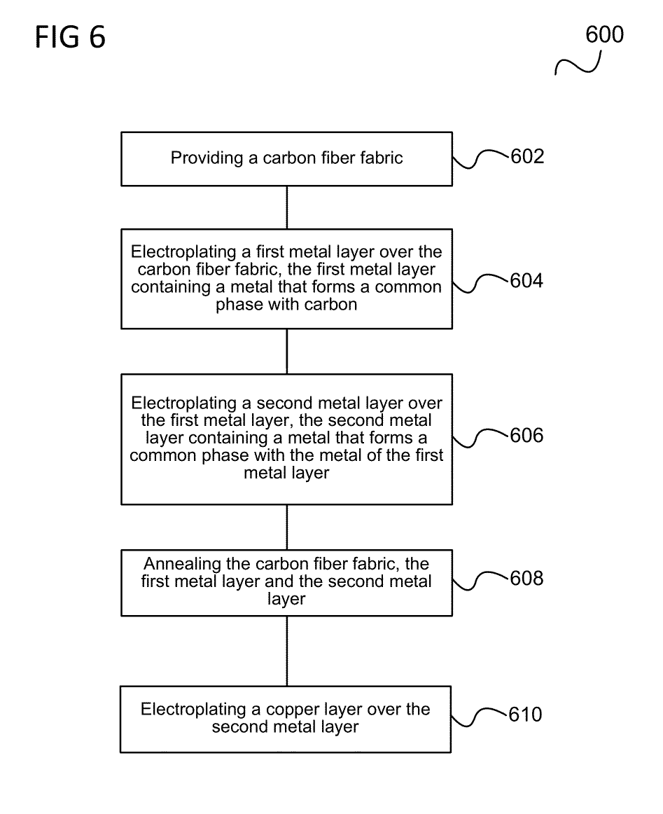

FIG. 6 shows a method for fabricating a carbon copper composite in accordance with another embodiment.

In 602, a carbon fiber fabric may be provided. The carbon fiber fabric may, for example, have or be made of a plurality of carbon fibers. The fabric and/or carbon fibers may, for example, be configured in accordance with one or more embodiments described herein.

In 604, a first metal layer may be electroplated over the carbon fiber fabric. Electroplating may, for example, be carried out in accordance with one or more embodiments described herein. The first metal layer may contain or consist of a metal that forms a common phase with carbon. The metal may, for example, be selected in accordance with one or more embodiments described herein. For example, in accordance with an embodiment, the metal may be chromium or manganese.

In 606, a second metal layer may be electroplated over the first metal layer. Electroplating may, for example, be carried out in accordance with one or more embodiments described herein. The second metal layer may contain or consist of a metal that forms a common phase with the metal of the first metal layer. The metal may, for example, be selected in accordance with one or more embodiments described herein. For example, in accordance with an embodiment, the metal may be nickel.

In 608, the carbon fiber fabric, the first metal layer and the second metal layer may be annealed. Annealing may, for example, be carried out in accordance with one or more embodiments described herein.

In 610, a copper layer may be electroplated over the second metal layer. Electroplating the copper layer may be effected using any suitable electroplating technique, which are known as such in the art.

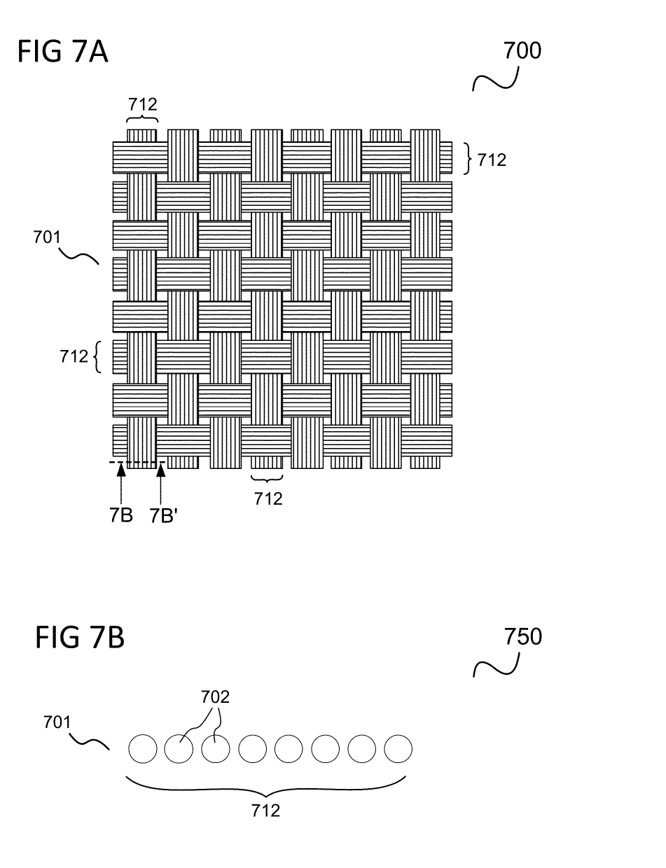

FIG. 7A to FIG. 10B illustrate various process stages in a method for fabricating a carbon copper composite in accordance with another embodiment.

FIG. 7A and FIG. 7B show, in a plan view 700 and a cross-sectional view 750 (corresponding to a cross-section along line 7B-7B′ in FIG. 7A), that a plurality of carbon fibers 702 may be provided. The number of carbon fibers 702 may be arbitrary, in general. The carbon fibers 702 may, for example, be arranged in bundles 712, wherein each bundle 712 may have one or a plurality of carbon fibers 702, as shown. The number of carbon fibers 702 per bundle 712 may be arbitrary, in general, and may be the same for each bundle 712 or may be different for different bundles 712.

The carbon fibers 702, or the bundles 712 of carbon fibers 702, may be arranged to form a fabric 701, as shown. In other words, a layer of carbon fibers 702 configured as a carbon fiber fabric 701 may be provided in accordance with some embodiments. In accordance with other embodiments, the carbon fibers 702 may be arranged differently. In accordance with one or more embodiments, one or more (e.g. all) of the carbon fibers 702 may include graphite.

At least one (for example a plurality, e.g. all) of the carbon fibers 702 may, for example, have a length in the millimeter range, for example a few millimeters. Other, e.g. higher, values may be possible as well in accordance with other embodiments.

At least one (for example a plurality, e.g. all) of the carbon fibers 702 may, for example, have a diameter in the range from about 1 μm to about 50 μm. Other values may be possible as well in accordance with other embodiments.

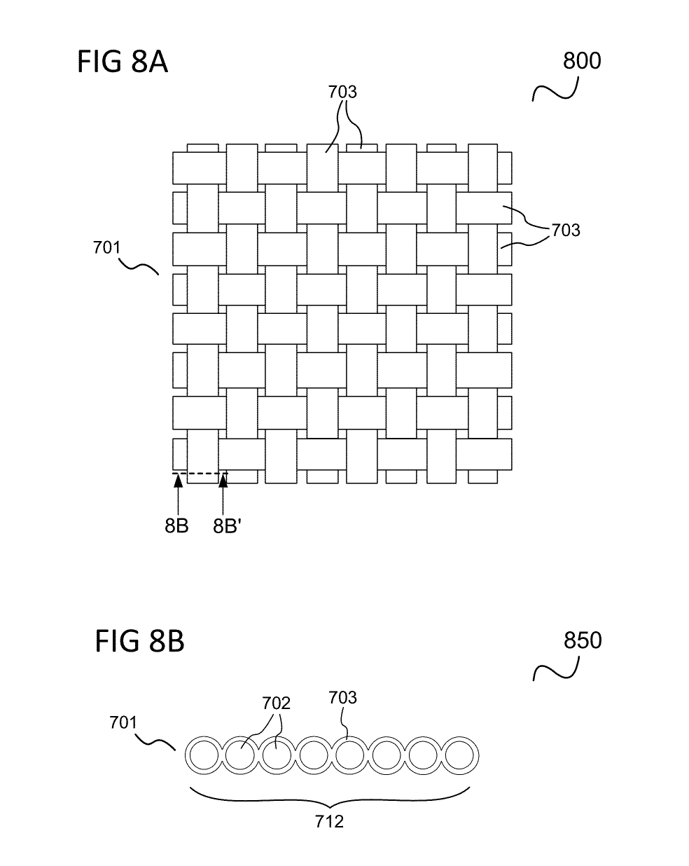

FIG. 8A and FIG. 8B show, in a plan view 800 and a cross-sectional view 850 (corresponding to a cross-section along line 8B-8B′ in FIG. 8A), that a first metal layer 703 may be electroplated over the carbon fiber fabric 701. Before depositing the first metal layer 703, the carbon fiber fabric 701 may optionally be pre-cleaned and/or degreased.

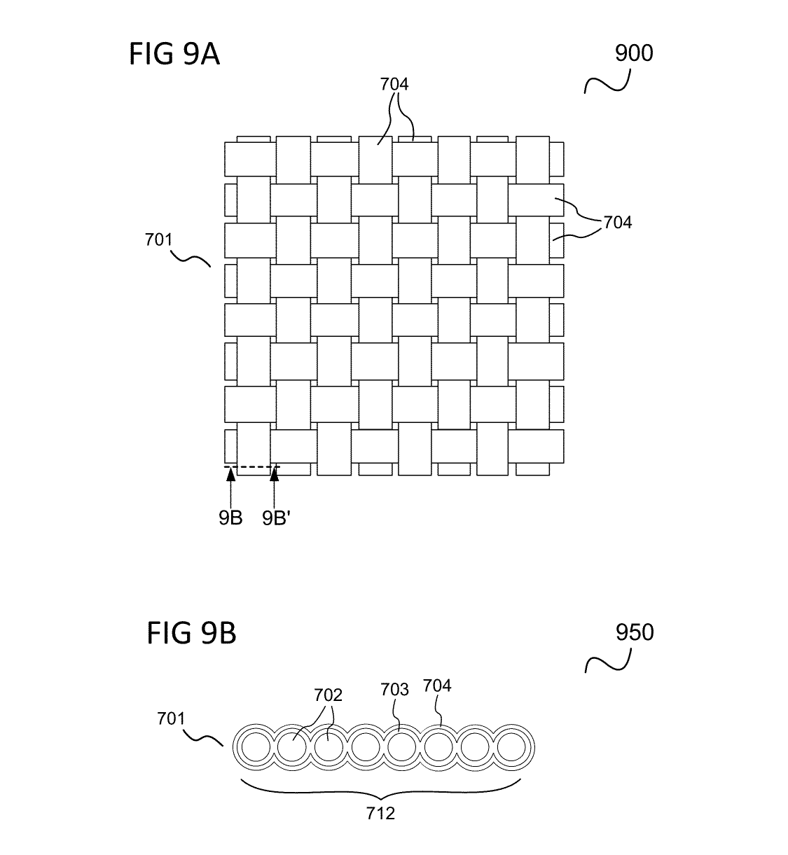

The first metal layer 703 may contain or consist of a metal, which forms a common phase with carbon, and a common phase with nickel to be deposited later (see FIG. 9A and FIG. 9B).

The first metal layer 703 may at least partially (e.g. fully) coat at least one (for example a plurality, e.g. all) of the carbon fibers 702, as shown.

Electroplating the first metal layer 703 may, for example, be achieved by pulsed electroplating.

A pulse frequency of pulses used in the pulsed electroplating may, for example, be in the range from about 10 kHz to about 1 MHz. Other values may be possible as well in accordance with other embodiments.

In accordance with another embodiment, a pulse height of pulses used in the pulsed electroplating may be in the range from about 4 V to about 12 V. Other values may be possible as well in accordance with other embodiments.

In accordance with other embodiments, electroplating the first metal layer may be effected by means of other suitable electroplating techniques.

The first metal layer 703 may be deposited such that it has a layer thickness that is smaller than the diameter of the carbon fibers 702, for example substantially smaller than the diameter of the carbon fibers 702, for example a layer thickness equal to or less than about 25% of the carbon fiber diameter, for example a layer thickness equal to or less than about 15% of the carbon fiber diameter, for example a layer thickness equal to or less than about 10% of the carbon fiber diameter, for example a layer thickness equal to or less than about 5% of the carbon fiber diameter, for example a layer thickness equal to or less than about 1% of the carbon fiber diameter, for example a layer thickness in the range from about 10 nm to about 500 nm. Other values may be possible as well in accordance with other embodiments. The minimal layer thickness may, for example, correspond to the size of crystallization seeds of the first metal layer 703.

FIG. 9A and FIG. 9B show, in a plan view 900 and a cross-sectional view 950 (corresponding to a cross-section along line 9B-9B′ in FIG. 9A), that a second metal layer 704 may be electroplated over the first metal layer 703.

The second metal layer 704 may contain or consist of nickel. The nickel of the second metal layer may form a common phase with the first of the first metal layer 703, as mentioned above.

The second metal layer 704 may at least partially (e.g. fully) coat at least one (for example a plurality, e.g. all) of the carbon fibers 702 coated with the first metal layer 703, as shown.

Electroplating the second metal layer 704 may, for example, be achieved by pulsed electroplating.

A pulse frequency of pulses used in the pulsed electroplating may, for example, be in the range from about 10 kHz to about 1 MHz. Other values may be possible as well in accordance with other embodiments.

In accordance with another embodiment, a pulse height of pulses used in the pulsed electroplating may be in the range from about 4 V to about 12 V. Other values may be possible as well in accordance with other embodiments.

In accordance with other embodiments, electroplating the second metal layer 704 may be effected by means of other suitable electroplating techniques.

The second metal layer 704 may be deposited such that it has a layer thickness that is smaller than the diameter of the carbon fibers 702, for example substantially smaller than the diameter of the carbon fibers 702, for example a layer thickness equal to or less than about 25% of the carbon fiber diameter, for example a layer thickness equal to or less than about 15% of the carbon fiber diameter, for example a layer thickness equal to or less than about 10% of the carbon fiber diameter, for example a layer thickness equal to or less than about 5% of the carbon fiber diameter, for example a layer thickness equal to or less than about 1% of the carbon fiber diameter, for example a layer thickness in the range from about 10 nm to about 500 nm. Other values may be possible as well in accordance with other embodiments. The minimal layer thickness may, for example, correspond to the size of crystallization seeds of the second metal layer 704.

The first metal layer 703 and the second metal layer 704 may, for example, have the same or substantially the same layer thickness. Alternatively, the layer thicknesses may be different.

The metal of the first metal layer 703 may be selected such that the metal of the first metal layer 703 is a metal which (for example, according to the corresponding phase diagrams) forms at least one common phase with carbon and at least one common phase with nickel, for example via solid state diffusion (in other words, movement and/or transport of atoms in solid phases) induced by annealing.

Examples for the metal of the first metal layer include chromium or manganese (for the first metal) as may be seen from FIGS. 11 to 14, which show phase diagrams 1100, 1200, 1300, 1400 of the binary systems carbon-chromium (C—Cr), carbon-manganese (C—Mn), chromium-nickel (Cr—Ni), and manganese-nickel (Mn—Ni), respectively.

Specifically, as may be seen from the phase diagram 1100 in FIG. 11, carbon (C) and chromium (Cr) may form at least one common phase.

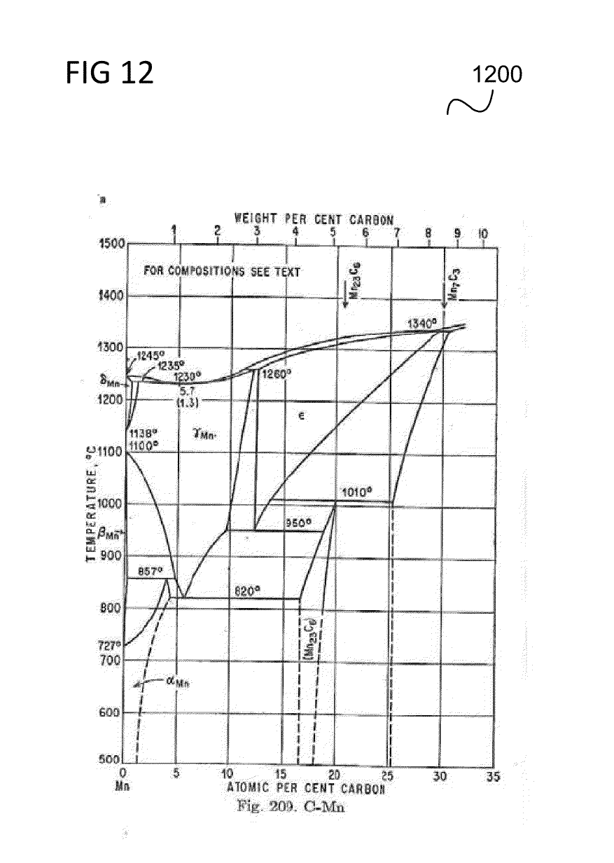

Furthermore, as may be seen from the phase diagram 1200 in FIG. 12, carbon (C) and manganese (Mn) may form at least one common phase.

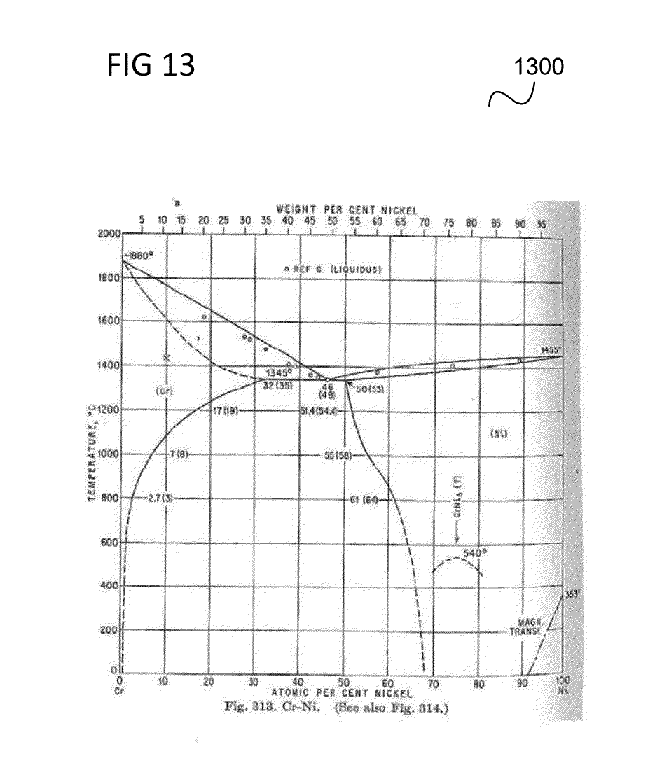

Furthermore, as may be seen from the phase diagram 1300 in FIG. 13, chromium (Cr) and nickel (Ni) may form at least one common phase.

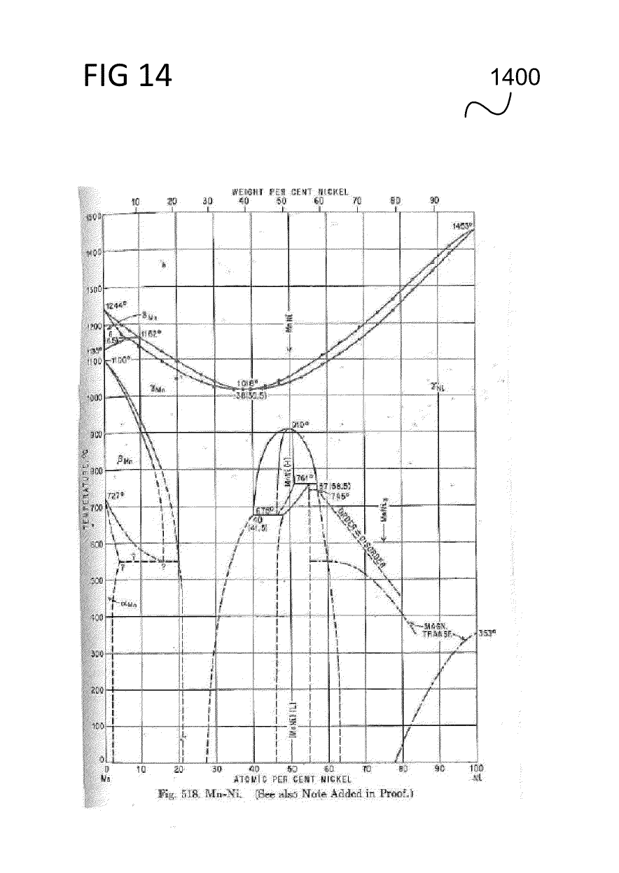

Furthermore, as may be seen from the phase diagram 1400 in FIG. 14, manganese (Mn) and nickel (Ni) may form at least one common phase.

Furthermore, nickel may adhere well to copper.

Alternatively, other combinations of metals may be possible for the first and second metal layers 703, 704.

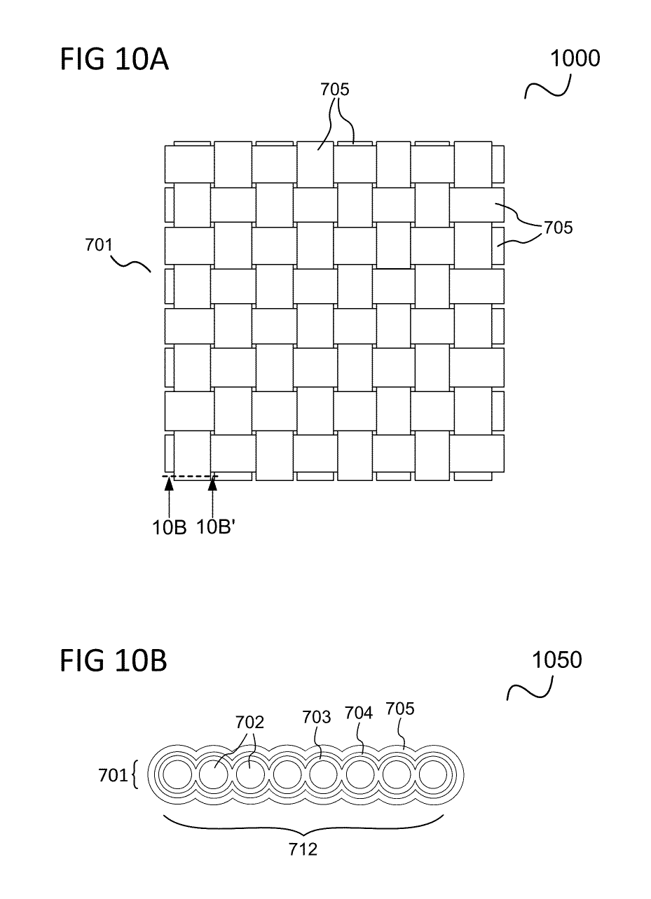

Illustratively, the first metal layer 703 and the second metal layer 704 may serve as adhesion layers to enable or improve adhesion of a copper layer 705 to be deposited later (see FIG. 10A and FIG. 10B).

The carbon fiber fabric 701 (including the carbon fibers 702), the first metal layer 703 and the second metal layer 704 may be annealed to form the common phases.

The fabric 701 and the metal layers 703, 704 may, for example, be annealed to a temperature in the range from about 400° C. to about 1000° C. Other values may be possible as well in accordance with other embodiments.

The fabric 701 and the metal layers 703, 704 may, for example, be annealed for a time duration in the range from about 1 h to about 10 h. Other values may be possible as well in accordance with other embodiments.

The fabric 701, the first metal layer 703 and the second metal layer 704 may be annealed simultaneously after deposition of the second metal layer 704 to form the common phases. In other words, a single annealing step may be carried out to anneal the fabric 701 and the metal layers 703, 704. However, it may also be possible to carry out a first annealing step before deposition of the second metal layer 704, and a second annealing step after deposition of the second metal layer 704 to anneal the fabric 701 and the metal layers 703, 704.

Annealing the fabric 701, the first metal layer 703 and the second metal layer 704 may serve to form a common phase of carbon (of the carbon fibers 702) and the metal of the first metal layer 703 (e.g. chromium or manganese), for example at an interface between the carbon fibers 702 and the first metal layer 703, and a common phase of the metal of the first metal layer 703 (e.g. chromium or manganese) and the metal of the second metal layer 704, for example at an interface between the first metal layer 703 and the second metal layer 704.

In accordance with another embodiment, a surface of the second metal layer 704 that faces away from the first metal layer 703 (illustratively, an outer surface of the second metal layer 704) may optionally be activated, for example in concentrated hydrochloric acid (e.g. for a short time interval of about 10 s to about 20 s), and/or cleaned (e.g. purged) after annealing the second metal layer 704.

FIG. 10A and FIG. 10B show, in a plan view 1000 and a cross-sectional view 1050 (corresponding to a cross-section along line 10B-10B′ in FIG. 10A), that a copper layer 705 may be electroplated over the second metal layer 704. Electroplating the copper layer 705 may be effected using any suitable electroplating technique, which are known as such in the art.

In accordance with another embodiment, voids possibly remaining between the plurality of metal-coated carbon fibers 702 after electroplating the copper layer 705 may be filled or joined with copper, for example galvanically or by means of hot pressing.

FIG. 10A and FIG. 10B illustratively show a carbon copper composite in accordance with an embodiment.

The carbon copper composite may include a plurality of carbon fibers 702. The carbon fibers 702 may, for example, be arranged to form a fabric 701, also referred to as carbon fiber fabric.

The carbon copper composite may further include a first metal layer 703. The first metal layer may 703 be disposed over the carbon fibers 702. The first metal layer 703 may contain or consist of a metal that forms a common phase with carbon and a common phase with nickel.

The carbon copper composite may further include a second metal layer 704. The second metal layer 704 may be disposed over the first metal layer 703. The second metal layer 704 may contain or consist of nickel. The metal of the first metal layer 703 may, for example, be chromium or manganese. Alternatively, any other combination of metals, which may meet the aforementioned conditions, may be used.

The carbon copper composite may further include a copper layer 705. The copper layer 705 may be disposed over the second metal layer 704.

Illustratively, FIG. 10A and FIG. 10B show a carbon copper composite that includes an adhesion layer stack 703/704 disposed between a layer of carbon fibers 702 and a copper layer 705, the layer stack 703/704 including two adhesion layers (in other words, layers establishing or improving adhesion between carbon and copper) disposed one over the other, i.e. the first metal layer 703 and the second metal layer 704.

In accordance with some embodiments, a carbon copper composite may include only one metal layer as adhesion layer disposed between the carbon fibers 702 and the copper layer 705. In this case, the metal layer may contain or consist of a metal that may form a common phase with carbon and a common phase with copper, for example chromium or manganese.

Carbon copper composites as described herein may, for example, be used as a heat sink for an electronic device such as, for example, a power electronic device or component (e.g. a high power module). To this end, the carbon copper composite may be attached to the electronic device, for example to a substrate of the electronic device.

In the following, various aspects and potential effects of various embodiments are described.

In accordance with various embodiments, one or more carbon fibers may be electrolytically coated with a metal that forms at least one common phase with carbon and at least one common phase with copper (according to the corresponding phase diagrams), and subsequently annealed to form a carbon-metal phase at the carbon-metal interface. The metal layer may illustratively serve as bonding agent or adhesion layer for a copper layer do be deposited later (in other words, as a layer that may enable or improve adhesion of the copper layer).

In accordance with various embodiments, one or more carbon fibers may be electrolytically coated with a metal layer stack including a first metal (e.g. chromium or manganese) that forms at least one common phase with carbon and a second metal (e.g. nickel) that forms at least one common phase with the first metal, and subsequently annealed to form a carbon-metal phase at the interface between the carbon fiber(s) and the first metal, and a metal-metal phase at the interface between the first metal and the second metal. The metal layer stack may illustratively serve as adhesion layer stack for a copper layer to be coupled to the carbon fibers (in other words, as a layer stack that may enable or improve adhesion of the copper layer on the carbon fibers).

In accordance with various embodiments, at least one metal layer may be electroplated onto one or more carbon fibers (e.g. a carbon fiber fabric) to serve as an adhesion layer or bonding agent to improve adhesion of a copper layer to be plated onto the fibers. The at least one metal layer may contain or consist of at least one metal (e.g. chromium or manganese) that forms at least one common phase with both carbon and copper.

In accordance with various embodiments, a copper layer may be electroplated onto the metal-coated carbon fiber(s), i.e. onto the carbon fiber(s) coated with the adhesion layer(s), thereby forming a carbon copper composite. The carbon copper composite may, for example, be used as heat sink material.

Thus, in accordance with various embodiments, a heat sink material or heat sink may be provided, e.g. for a power electronic device or power electronic component such as e.g. a high power module (e.g. IGBT (insulated gate bipolar transistor) module)), based on a carbon copper composite.

The carbon copper composite including the carbon fibers and copper may have a coefficient of thermal expansion (CTE), which is much closer to the CTE of silicon than the CTE of pure copper. Therefore, the carbon copper composite may greatly reduce thermal stress and chip bending when used as heat sink material.

One aspect of various embodiments may be seen in that carbon fibers may be provided with a surface that enables cold fabrication of a carbon copper composite directly at a wafer.

Another aspect of various embodiments may be seen in that methods are provided, by means of which a composite of carbon fibers and copper (CCu) may be adapted to become suitable for many temperature cycles.

Another aspect of various embodiments may be seen in that one or more of the drawbacks of the above-described conventional method for fabricating a CCu composite may be obviated or substantially reduced.

For example, a sintering process as in the conventional method may not be needed to fabricate a CCu composite. Thus, a cold fabrication of a CCu composite directly at a wafer becomes possible. Furthermore, no additives may be needed in the copper electrolyte to improve adhesion of the copper.

Another aspect of various embodiments may be seen in that a CCu composite may be provided that may be suitable for thermal cycling, for example a CCu composite that may resist many temperature cycles with no or substantially no degradation.

According to various embodiments, at least one bonding agent is provided on the carbon fibers. The bonding agent may be realized by a galvanic coating of a metal, which forms at least one common phase with carbon, and with the later-deposited copper.

Examples of metals, which may be deposited relatively easily by means of aqueous electrolysis, include, for example, chromium and manganese.

According to some embodiments, a layer of nickel may be deposited as additional (second) intermediate layer after deposition of a first metal layer (chromium or manganese layer), which forms a common phase with both chromium and manganese.

According to various embodiments, the common phase between carbon and the first metal may be formed by means of a temperature treatment (annealing). According to some embodiments, the annealing may be carried out in the presence of the second metal (nickel).

According to some embodiments, an oxide layer, which may possibly be generated on the surface of the second metal layer (nickel layer) during the annealing, may be removed, for example by bringing the oxidized metal layer into contact with an acid such as concentrated hydrochloric acid, thereby activating the surface for a subsequent electrolytic copper plating.

According to some embodiments, carbon fibers may be provided with a double pre-coating, including a first galvanically deposited metal layer (e.g. chromium or manganese layer) and a second galvanically deposited metal layer (nickel layer) deposited over the first metal layer.

According to some embodiments, the deposition of the metal layer or layers onto the carbon fibers may be carried out using a galvanic pulse deposition. By means of a galvanic pulse deposition, a very thin and/or homogeneous coating may be achieve, since crystallization seeds may become smaller with increasing difference in the chemical potential between the starting species of the metal to be deposited (i.e. the electrolytic solution) and the final state (i.e. the metallic film). For example, layer thicknesses down to approximately the seed size may be achieved by means of galvanic pulse deposition.

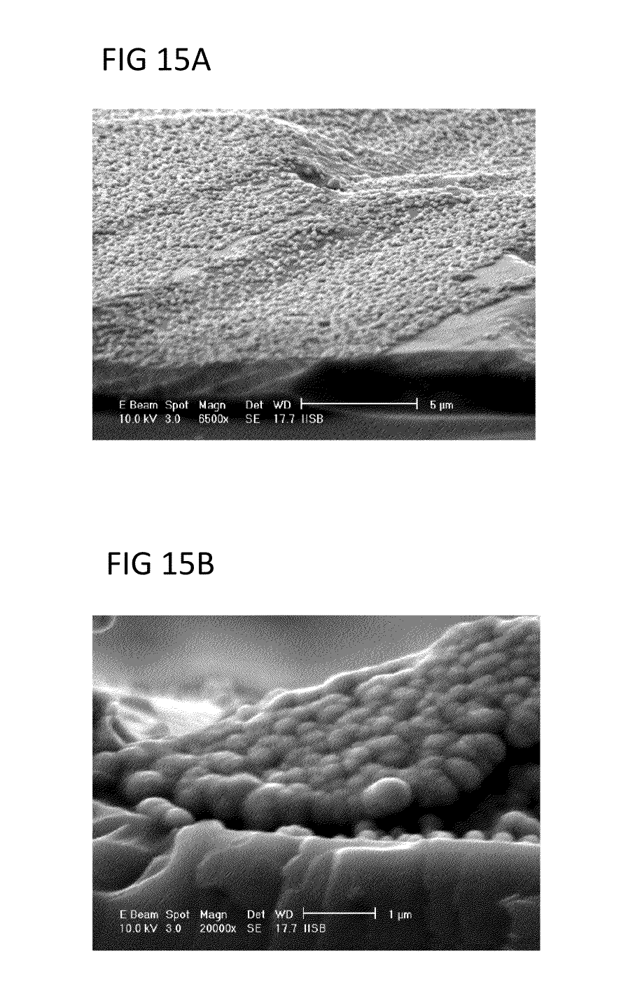

FIG. 15A and FIG. 15B show two electron micrographs illustrating seed formation in galvanic pulse deposition of nickel on silicon, wherein FIG. 15B is a magnification of a part of FIG. 15A. The micrographs serve as an example to illustrate how pulse height and/or pulse width of a pulse galvanic may influence size, density and/or layer thickness of seeds of a metallic coating. The figures show that very thin layer thicknesses may be achieved with galvanic pulse deposition.

Reducing the thickness of the metal coating (i.e. of the adhesion layer or layers) may improve the thermal and/or electrical conductivity of the carbon copper composite.

In accordance with some embodiments, an adhesion layer stack may be provided for a cold electrolytic fabrication of a carbon fiber-copper composite material, wherein a first metal, e.g. chromium or manganese (or any other material that forms a common phase with both carbon and nickel), is deposited onto a (e.g. pre-cleaned and degreased) carbon fiber fabric by means of electrolytic deposition (e.g. galvanic pulse deposition) in aqueous solution, and wherein subsequently nickel is deposited onto the first metal (also by electrolytic deposition, e.g. galvanic pulse deposition). The adhesion metals may be substantially thinner than the diameter of the carbon fibers. Subsequently, the carbon fiber fabric provided with the metallic adhesion layer stack may be annealed (in other words, heated or tempered). Subsequently, the nickel surface may be activated for a short time interval in concentrated hydrochloric acid and purged. Subsequently, copper may be deposited by means of electrolytic deposition. Possibly remaining voids may be connected with copper, e.g. galvanically and/or by means of hot pressing.

A method for fabricating a carbon copper composite in accordance with another embodiment may include: providing a first layer, the first layer having or being made of a plurality of carbon fibers; electroplating a metal layer over the first layer, the metal layer containing or consisting of a metal that forms a common phase with carbon and a common phase with copper; annealing at least the first layer and the metal layer; electroplating a second layer over the metal layer, the second layer containing or consisting of copper.

A method for fabricating a carbon copper composite in accordance with another embodiment may include: providing a first layer, the first layer having or being made of a plurality of carbon fibers; electroplating a first metal layer over the first layer, the first metal layer containing or consisting of a first metal, and electroplating a second metal layer over the first metal layer, the second metal layer containing or consisting of a second metal, wherein the first metal and the second metal are selected such that the first metal and carbon form a common phase and the first metal and the second metal form a common phase; annealing the first layer, the first metal layer and the second metal layer; electroplating a second layer over the second metal layer, the second layer containing or consisting of copper.

A method for fabricating a carbon copper composite in accordance with another embodiment may include: providing a fabric having a plurality of carbon fibers; electroplating at least one metal layer over the fabric, the at least one metal layer containing or consisting of a metal that forms at least one common phase with carbon and at least one common phase with copper; annealing the fabric and the at least one metal layer; electroplating a copper layer over the at least one metal layer.

A carbon copper composite in accordance with another embodiment may include: a first layer, the first layer containing or consisting of a plurality of carbon fibers; a metal layer disposed over the first layer, the metal layer containing or consisting of a metal that forms a common phase with carbon and a common phase with copper; a second layer disposed over the metal layer, the second layer containing or consisting of copper.

In accordance with various embodiments, a method for fabricating a carbon copper composite may include: providing a carbon fiber fabric; electroplating a first metal layer over the carbon fiber fabric, the first metal layer containing or consisting of a metal that forms a common phase with carbon (e.g. chromium or manganese); electroplating a second metal layer over the first metal layer, the second metal layer containing or consisting of nickel; annealing the carbon fiber fabric, the first metal layer and the second metal layer; electroplating a copper layer over the second metal layer.

In accordance with various embodiments, a method for fabricating a carbon copper composite may include: providing a fabric having a plurality of carbon fibers; electroplating the carbon fibers with at least one metal to form metal-coated carbon fibers, the at least one metal being selected from a group of metals that form at least one common phase with carbon and at least one common phase with copper; annealing the fabric having the metal-coated carbon fibers; electroplating the metal-coated carbon fibers with copper.

In accordance with various embodiments, a method for fabricating a carbon copper composite may include: providing a fabric having a plurality of carbon fibers; electroplating the carbon fibers with a layer stack including a first metal layer and a second metal layer disposed over the first metal layer to form metal-coated carbon fibers, the first metal layer containing or being made of a first metal and the second metal layer containing or being made of a second metal, wherein the first metal and the second metal are selected such that the first metal forms a common phase with carbon and a common phase with the second metal; annealing the fabric having the metal-coated carbon fibers; electroplating the metal-coated carbon fibers with copper.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A method for processing at least one carbon fiber, comprising:
electroplating a metal layer over at least one carbon fiber, wherein the metal layer comprises a metal, which forms a common phase with carbon and a common phase with copper;
annealing the at least one carbon fiber and the metal layer.

2. The method of claim 1,
wherein the metal is chromium or manganese.

3. The method of claim 1,
wherein electroplating the metal layer comprises pulsed electroplating.

4. The method of claim 1, further comprising:
electroplating a copper layer over the metal layer.

5. A method for processing at least one carbon fiber, comprising:
electroplating a first metal layer over at least one carbon fiber, wherein the first metal layer comprises a metal, which forms a common phase with carbon and a common phase with nickel;
electroplating a second metal layer over the first metal layer, wherein the second metal layer comprises nickel;
annealing the at least one carbon fiber, the first metal layer and the second metal layer.

6. The method of claim 5,
wherein the metal is chromium or manganese.

7. The method of claim 5,
wherein at least one of electroplating the first metal layer and electroplating second metal layer comprises pulsed electroplating.

8. The method of claim 5, further comprising at least one of activating and cleaning a surface of the second metal layer after annealing the second metal layer.

9. The method of claim 5, further comprising:
electroplating a copper layer over the second metal layer.

10. A method for fabricating a carbon copper composite, comprising:
providing a plurality of carbon fibers;
electroplating a metal layer over the plurality of carbon fibers, wherein the metal layer comprises a metal, which forms a common phase with carbon and a common phase with copper;
annealing the plurality of carbon fibers and the metal layer;
electroplating a copper layer over the metal layer.

11. The method of claim 10,
wherein the metal is chromium or manganese.

12. The method of claim 10,
wherein electroplating the metal layer comprises pulsed electroplating.

13. The method of claim 10,
wherein the plurality of carbon fibers is configured as a fabric.

14. A method for fabricating a carbon copper composite, comprising:
providing a plurality of carbon fibers;
electroplating a first metal layer over the plurality of carbon fibers, wherein the first metal layer comprises a metal, which forms a common phase with carbon and a common phase with nickel;
electroplating a second metal layer over the first metal layer, wherein the second metal layer comprises nickel;
annealing the plurality of carbon fibers, the first metal layer and the second metal layer;
electroplating a copper layer over the second metal layer.

15. The method of claim 14,
wherein the first metal is chromium or manganese.

16. The method of claim 14,
wherein at least one of electroplating the first metal layer and electroplating the second metal layer comprises pulsed electroplating.

17. The method of claim 14, further comprising at least one of activating and cleaning a surface of the second metal layer before electroplating the copper layer over the second metal layer.

18. The method of claim 14,
wherein the plurality of carbon fibers is configured as a fabric.

19. A method for fabricating a carbon copper composite, the method comprising:
providing a carbon fiber fabric;
electroplating a first metal layer onto the fabric, the first metal layer comprising chromium or manganese;
electroplating a second metal layer onto the first metal layer, the second metal layer comprising nickel;
annealing the fabric, the first metal layer and the second metal layer;
electroplating a copper layer onto the second metal layer.

20. The method of claim 19,
wherein electroplating of at least one of the first and second metal layers comprises pulsed electroplating.

21. The method of claim 19, further comprising at least one of activating and cleaning a surface of the second metal layer before electroplating the copper layer over the second metal layer.

22. A carbon copper composite, comprising:
a plurality of carbon fibers;
a metal layer disposed over the carbon fibers, the metal layer comprising a metal that forms a common phase with carbon and a common phase with copper;
a copper layer disposed over the metal layer.

23. The carbon copper composite of claim 22,
wherein the metal is chromium or manganese.

24. A carbon copper composite, comprising:
a plurality of carbon fibers;
a first metal layer disposed over the carbon fibers, wherein the first metal layer comprises a metal, which forms a common phase with carbon and a common phase with nickel;
a second metal layer disposed over the first metal layer, wherein the second metal layer comprises nickel;
a copper layer disposed over the second metal layer.

25. The carbon copper composite of claim 24, wherein the first metal is chromium or manganese.
